(19) United States
(12) Patent Application Publication
(10) Pub. No.: US 2021/0368800 A1
(43) Pub. Date: Dec. 2, 2021

(54) Quickly, easily, and economically creating and maintaining a low bio-load on surfaces that may be large and/or of complex contour and finish

(71) Applicant: Pete John Chambers, Arlington, VA (US)

(72) Inventor: Pete John Chambers, Arlington, VA (US)

(21) Appl. No.: 16/889,004

(22) Filed: Jun. 1, 2020

(51) Int. Cl. A01N 59/00; A01N 33/12

(52) U.S. Cl. CPC A01N 59/00; A01N 33/12

(57) ABSTRACT

The surface(s) of an enclosed space volume—for example a room, classroom, hospital room or the interior of a vehicle, i.e., an aircraft, truck or automobile—is treated in a process of mechanical and chemical steps as to quickly, economically and significantly reduce the bio-load with (1) little environmental impact and (2) small logistics support. Preferably both sodium hydroxide (NaOH) and hypochlorous acid (HClO) are sequentially made at the place and time of application, preferably from salt (NaCl) and water (H2O) in the same apparatus. The sodium hydroxide is first applied onto a surface, preferably by electrostatic spraying. Visible bio-load residue on the treated surface is then mechanically removed with PVA wipes. Spent wipes are preferably safely and easily sanitized in boiling water, and conveniently disposed of as a liquid, non-bio-hazard, waste. The cleaned dry surface is then sanitized and disinfected with hypochlorous acid (HCIO), preferably by again spraying using the same electrostatic spraying system. Sanitation may be indefinitely renewed by repeated applications of hypochlorous acid and/or liquid anti-microbial.

### BACKGROUND OF THE INVENTION

### 1. Field of the Invention

The present invention generally concerns the cleaning and disinfecting of surfaces, and particularly concerns the quick easy and economical creation and maintenance of a generally clean low bio-load on surfaces that may be large and/or of complex contour.

### 2. Background of the Invention

2.1 The requirement for a flexible and potent method and system for reducing bio-loads on surfaces, especially large and/or rough and/or geometrically complex surfaces that may be difficult to access.

A need exists circa 2019 for the quick, quality and cost effective disinfection of bio-contaminated surfaces that may be any of (1) large and very large, and (2) complex in contour, (3) possessed of a rough or otherwise contaminant-retaining surface finish, (4) extensively contaminated with extremely hazardous biologicals such as the COVID-19 virus, and/or (5) difficult to access. The disinfection need not always be to the level of surface sterilization, but is preferably to that level or near to that level, thus providing the sanitary standard of a hospital operating theater.

For example, the United States Air Force presently has a severe, and expensive, challenge to clean and disinfect the typically large and complex contour interior surfaces of medical evacuation aircraft, particularly including helicopters. These surfaces must be effectively cleaned and disinfected—strongly preferably quickly and at reasonable cost—to prevent the introduction of Acinetobacter Calcoaceticus to wounded soldiers during transport. There are many obstacles to solving this problem.

First, the desired clinical outcomes must be defined, and validated to be realized by whatsoever cleaning and disinfecting materials and methods are adopted.

Second, the material(s) and method(s) of cleaning and disinfection must be validated to work over a large range of surface dimensions and contours, and with varied and disparate materials considerations. Strongly preferably the cleaning and disinfection would transpire rapidly using only unskilled or semi-skilled (i.e., untrained) labor, and the turnaround times of the aircraft would be short. Little or no logistics footprint and support for any adopted cleaning and disinfecting materials and methods would be desirable. Preferred materials and any accompanying preferred method(s) would preferably have little or no environmental impact; i.e., they would be “green”.

Third, the preferred materials and any accompanying preferred method(s) must have no effect on the aircraft, aircraft systems, or any aspects of the air transport operational. Finally, the disinfection method(s) and system(s) must be broadly effective even against diverse and infectious biological contamination(s), particularly including the new (circa 2020) coronavirus called SARS-CoV-2, or COVID-19.

Some small thought will reveal that this is a demanding list of requirements. The fact that it is not currently, circa 2019, readily satisfied is causing that upwards of eight hours tortuous hazardous skilled labor by each of up to three people and upwards of $500 (circa 2019) disinfectant and cleansers must used in and over periods in excess of eight hours to clean (the interiors of) certain helicopters. As may well be imagined, if a patient hemorrhages or evacuates into the aircrafts—a quite normal and unavoidable occurrence—during transport then this difficult cleaning and disinfection must absolutely be timely and well done (for the benefit of all), and the cost and the impact on air operations is considerable. (If the patient is airlifted from a biologically hazardous zone then controlling the bio-hazard state of the aircraft is a major consideration in warfighting.)

Needless to say the cleansing and disinfecting of the challenging interior surfaces of medical aircraft is an egregious example, but not the only one. The interiors of certain medical operating theaters and of biological laboratories can be very diverse and complex, and the cleaning and disinfecting of these volumes can be any of onerous, dangerous, time-consuming, and/or expensive.

### 2.2 Certain Generally Relevant Prior Art

In development of the present invention many materials and technologies were considered towards realizing the goal of efficiently and effectively making large and/or complex contour and/or rough surfaces—especially as may exist in the interiors of air transports—functionally antimicrobial. Desirably, the entirety of all treated surfaces need to be rendered clean and uncontaminated, and as close to “as-newly-manufactured status” as is possible. The following generally separate materials and technologies were researched and evaluated before being integrated into the single new process, and bio-load reduction system, of the present invention.

First, common sense dictates that a volume to be cleaned and sanitized first be cleaned of general trash and visible bio-loads. The present invention incorporates no new, nor any particular, insights in this area, but it will be understood that when the availability of, for example, building and vehicles of opportunity as well as aircraft and operating rooms having operational costs ranging to thousands of dollars per hour is dependent upon reduction of bio-load, it is penny wise and pound foolish to skip on disposable brushes, pads and wipes, shovels and trowels, buckets and anything else useful to mechanical removal of bulk trash.

Next, it will be seen that the present invention preferably uses both Sodium Hydroxide (NaOH) and Hypochlorous Acid (HClO), and most preferably only these two chemicals in dilute water solution. It is known to use equipment(s) to manufacture both sodium hydroxide (NaOH) and hypochlorous acid (HClO). See, for example, U.S. Pats. Nos. 7,374,645; 7,691,249; 7,691,249 B2; 8,002,955 B2 and 9,347,140 B2, all dealing with this subject. So also do Japanese patent no. 5118889 and Singapore patent no. 178422. Note that either, or both, Sodium Hydroxide (NaOH) and Hypochlorous Acid (HCIO) may be created from simple ingredients—namely, water (H2O) and salt (NaCl)—and electricity.

Next, it is known to apply, at least, sodium hydroxide (NaOH) by an electrostatic spraying system as is taught in U.S. Pat. No. 8,985,051.

Next, it is known that PVA wipes are effective to mechanically remove visible bio-load residue(s) and to leave a dry surface. For example, see U.S. Pat. Nos. 5,707,731; 2160682; 971994056; 5,885,907; 5,985,443; 6,420,284; 2,392,034; 1419848; 1237820; D493,946/7,328,463; and 7,509,690.

It is further known that a long acting liquid anti-microbial agent may be sprayed, including with an electrostatic sprayer. See U.S. Pat. No. 8,491,922 B2, although this patent particularly deals with an antimicrobial isopropyl alcohol and organofunctional silane solution different from the preferred anti-microbial solutions of the present invention.

Finally, and although not an integral part of the present invention, it known that it is both useful and prudent to both establish and monitor track and trace) bio-loads on surfaces of interest. To accomplish this an ATP meter should be used as a quick assay to determine baseline and success of any cleaning and/or disinfecting materials and methods used (and is so usable to determine the efficacy of the present invention). See, for example, U.S. Pat. No. 7,628,823 B2 and patent application no. 20080176250.

Note further that ATP technology as it currently exists measures total Bio-Load (living and dead). Additional laboratory quality testing is preferably periodically utilized to confirm the accuracy of the ATP results. There are several emerging testing technologies based on ELISA that show promise and can improve the overall quality of this process. See U.S. Pat. No. 8,715,590 In addition, additional antimicrobial longevity technology is constantly being introduced and should be included in any system of improved bio-load reduction systems, i.e. PCO Cluster ion technology.

### 2.3 Certain Specifically Relevant Prior Art

As discussed in the previous section the method of the present invention will be seen to most preferably use diluted solutions of Sodium Hydroxide (NaOH) and Hypochlorous Acid (HClO). Both these chemicals and their superlative anti-microbial properties are well known and well understood, but are perhaps not as generally and widely used in the United States circa 2020 as might be possible because, in the opinion of the inventor, it is hard for commercial interests to make significant money from their manufacture and supply, being that both chemicals can be inexpensively and easily made from water, salt, and electricity.

Nonetheless to their low cost and simplicity both chemicals have, as stated, superlative anti-microbial properties. Further, both chemicals are non-toxic, and can even be safely imbibed at low potency. Both chemicals are environmentally benign, and require no special handling or clean-up.

In particular, it is reported on the Internet at “The Maritime Executive” website circa March 2020, that “[s]anitation is an essential component of cruise ship operation, and in recent months it has become an even more critical component. Global port authorities around the world are carefully screening for COVID-19 coronavirus along with other illnesses such as the common flu, all of which could lead to delays or denial of permission for ships to enter ports . . . This new health challenge calls for new sanitation solutions. [Cruise] ships usually use heavy-duty chemical disinfectants, but there is a better and safer way. Electrolyzed water also known as hypochlorous acid (HCIO)—is a highly effective and intrinsically safe sanitizing agent, and it can be generated in unlimited quantities . . . ”

“The single most important feature of hypochlorous acid is that it is unusually efficient in eliminating viruses. One of the big reasons why people are switching over is efficacy. Working with Norwegian Cruise Line, we did research at a FDA-approved lab proving that electrolytically generated hypochlorous acid can kill norovirus in less than one minute at 50 ppm. Given that norovirus is listed by the CDC as one of the top five food borne pathogens, this has huge implications not just for general sanitation but also for food sanitation and food contact surface sanitation,” says Dr. Scott Hartnett, chief medical officer at EcoloxTech.

“National and international reference laboratories have proven that HCIO works very well against viruses, including norovirus and human coronaviruses. One study is of particular interest: in 2016, researchers at the University of Washington School of Public Health found that HCIO was more than 99.999 percent effective in eliminating coronavirus 0C43, which is similar to COVID-19.

“[The] hypochlorous acid system on board because of its proven effectiveness in killing bacteria, fungi and viruses,” says Robert Wilkinson, Senior Director of Environmental Health and Occupational Safety for Norwegian Cruise Line Holdings. “It reduces our dependence on the usual harsh chemicals and provides and additional layer of safety for our crewmembers and guests. Our shipboard teams truly appreciate the deployment of this new technology.”

“Wilkinson notes that HCIO is the rare single product that can be used to disinfect every compartment onboard, from galleys and dining areas to cabins. HICO that is generated . . . is FDA-cleared for washing fish and seafood, fruits and vegetables and sanitation of food prep surfaces without rinsing—making it a perfect choice for the galley . . . It is also listed by the USDA as an authorized material for use in organic food production.

“For large-scale disinfection, HCIO can be dispensed using a fogger without any chemical-related PPE for workers. HCIO is intrinsically safe, as it is non-irritant and the human body produces the same molecule for self-defense. In fact, it is so safe to inhale that it is being evaluated as a treatment for throat and lung infections. By contrast, the preparatory steps required for other fogging agents of similar power—products based on peracetic acid, ozone, chlorine dioxide or peroxides—require considerable time and expense.

“In hotel areas of the ship, HCIO has an extra edge over bleach and peroxide-based chemicals because it will not cause discoloration of most carpets, furniture and textiles. This is a critical economic and operational consideration when disinfecting hundreds of cabins.

“This very high efficacy disinfection combined with economical cost concurs with the opinion of the inventor. Notably, the challenging metal spaces of cruise ships, other ships and submarines, and of aircraft, are exactly the kinds of surfaces dealt with by the method and system of the present invention.

### SUMMARY OF THE INVENTION

The present invention encompasses a process of cleaning, disinfecting, and preparing a surface to become in and of itself anti-microbial. The cleaned and disinfected surface may be (but need not be) large to very large, ranging to several square meters and more in size. The surface may be of complex contour(s), for example an interior compartment of an aircraft. The surface may be of diverse materials and textures, with diverse surface finishes and features. For example, the surface may have and present the heads of rivets, as might an interior compartment of a helicopter.

The method of the present invention for disinfecting a surface basically includes as a step one first-applying sodium hydroxide to the surface as a cleaner, and wiping the surface dry; as a step two second-applying hypochlorous acid to the surface as a disinfectant; and as a step three third-applying a covalent bonded anti-microbial to the surface.

This basic method may be ameliorated, improved and extended by, before the step two, producing the sodium hydroxide onsite where is located the surface. This producing is of sodium hydroxide is preferably at such low ppm so as not to be toxic. This producing is preferably of sodium hydroxide containing an effective concentration of reactive ions. Any production of sodium hydroxide for use in cleaning step two by an alternative method of dilution from high concentrates would also need to contain an effective concentration of reactive ions.

This effective concentration may eventually be set by emergent standards. Finally this producing is preferably of sodium hydroxide having less than 10 ppm salt content. This preferred ppm must be considered to be a difficult number that can be deviated from because of the different methods of production. One sodium hydroxide producing machine produces 160-200 ppm. A concentration of 400 ppm can be as effective as 3000 ppm if the sodium hydroxide is produced from powder. Consequently the ppm concentration is a moving target by the manufacturer of any machine producing sodium hydroxide. Also, salt content is variable but, a target number of less than 10 ppm is as good as any.

The basic method may be further, or otherwise, be ameliorated, improved and extended by, again most preferably before the step two, producing hypochlorous acid onsite where is the surface. This producing is of hypochlorous acid [HClO] is preferably of HClO having a pH between 4 and 6.5.

Optimally both the sodium hydroxide and hypochlorous acid are produced onsite where is located the surface to be disinfected. Optimally this producing of both the sodium hydroxide and hypochlorous acid onsite where is located the surface is simultaneous in a same deployable device, using only simple ingredients and electricity.

In any, and in all, of this producing of sodium hydroxide and hypochlorous acid onsite where is located the surface the producing preferably uses only the (1) commonly available and (2) inexpensive, elements (a) salt (NaCl) and (b) water (H2O).

The wiping dry of the surface after the application of the sodium hydroxide in step one is preferably with PVA wipes. The wipes and any matter including biological matter that they serve to pick up may be easily sterilized and reduced to liquid in boiling water. The spent wipes are thereafter suitably disposed of as conventional waste, and need not be treated as biological waste.

The basic method may be easily and economically expanded and extended to maintaining disinfected the surface so treated, the expanded and extended method simply consisting of repeating as necessary steps one and two.

The basic method is effective to kill diverse microbes. Among other biologicals it will reliably kill fungus including sometimes-difficult-to-kill, hospital fungus, yeast, bacteria, and virus. It will reliably kill Acinctobacter Calcoaceticus. The basic method is preliminarily believed as of the date of the filing of this application to also be more than 99.999 percent effective in eliminating coronavirus COVID-19.

In the basic method the step three of third-applying a covalent bonded anti-microbial to the surface may consist of applying quaternary ammonium cations (quats).

These and other aspects and applications of the present invention will become increasingly clear upon reference to the following specification.

### DESCRIPTION OF THE PREFERRED EMBODIMENT

The present invention is directed to cost effectively and effectively cleaning surfaces economically in both labor and material(s) used. By surfaces it is meant herein any kind of surfaces typically found in any building, aircraft, motor vehicle, water craft, finished or preassembled product, enclosed environments—walls, ceiling, floors, infrastructure support systems—HVAC, water, etc. This also, includes surfaces to be used in exterior environments—walls, metal, and synthetic. Despite being so versatile, and broadly effective, surface cleaning and disinfection in accordance with the present invention is “first rate”, and, in particular, surfaces proximate to, or used to support, medical procedures may be effectively disinfected. This not only includes conventional hospital operating rooms, but surfaces such as the insides of medical evacuation helicopters. The patient bays of medical evacuation helicopters of the United States Air Force have proven to be needful of disinfection, and this task has have proven in practice to be extraordinarily difficult to perform, requiring any one or ones of (1) skilled and focused and dedicated labor ranging to tens of hours in a hazardous environment, (2) copious specialty disinfectant chemicals ranging to hundreds of dollars in cost, and, most adversely, (3) tremendous delay in the turn-around mission time of the aircraft. This process, and the results of the process, typically fall within the parameters and oversight of several regulations and standards appropriate to the (1) purposes applied, and (2) surfaces disinfected. Moreover, the ability to track and tracing the successful outcomes of cleaning and disinfection in accordance with the present invention may readily be realized using a series of interchangeable and evolving patented technologies. The present invention is so broadly (1) applicable and (2) effective that enumeration of particular regulations, standards, and/or proofs of effectiveness is not deemed relevant, and, short of attaining the “gold standard” of surface sterilization, the inventor does not know of any surface presenting any biological contamination problem that cannot be as effectively, efficiently and economically decontaminated with the method and system of the present invention as any other common method or system—chemical or radiological or whatever. Considering that (1) surfaces are diverse, and (2) humans have cleaned for thousands of years, this is arguably saying quite a lot.

When the following most preferred method of the present invention is conscientiously followed no case has of yet been identified where appreciable visible biomass—let alone harmful biomass—remains on the cleaned and sterilized surface. This of course includes viruses and, in particular, the COVID-19 virus. Prior to commencing the method of the present invention bulk trash and contamination is conventionally removed from the surface(s) to be cleaned and disinfected, as is dictated by common sense “Generally Clean”. Conventional tools such as brooms, bushes, pads, and scraping instruments may be conventionally employed. If the removed bulk material constitutes a biohazard—as is common—then consideration should be given to on-site sterilization by immersing this waste in the same boiling water that will later be discussed as a preferred means of disposing of spent PVA wipes preferably used after a sodium hydroxide application step of the present invention.

The method of the present invention proper may be considered to commence with the application of sodium hydroxide [NaOH] to a surface. There are no, or insubstantial, limitations on what the surface may be composed of, or its geometric contour, or its finish from considerable roughness to high polish, the existence of surface features such as bolt and/or rivet heads, and/or reasonable surface temperature. Clearly the surface must not be so overlaid with loose trash that it cannot be wetted with the sodium hydroxide.

Casual basic and rudimentary gross removal of extraneous matter from a surface prior to its cleaning and disinfection (in accordance with the method of the present invention) normally presents no problem, and most often the surface is thoroughly wetted with liquid sodium hydroxide by process of spraying. The most preferred sodium hydroxide is in (sprayable, and sprayed) solution with water to a concentration of <0.04% Sodium Hydroxide having a pH>11.5.

This preferred sodium hydroxide solution (1) converts fats & oils into soap and washes them away, (2) denatures proteins, and (3) releases dirt and organic matter a layer at a time, where (4) electrically-activated ions produce high strength degreasing at low concentrations.

This preferred sodium hydroxide solution is environmentally safe, and has a low carbon footprint. Most preferably no surfactants, anti-foaming agents, perfumes or other additives are used. The spent solution is capturable, and captured, like as would be common water, and is rapidly neutralized when recombined in any reasonable modern waste management system. In short, despite its effectiveness to clean, the sodium hydroxide solution it is not particularly noxious or offensive to humans using the solution.

Spent solution not otherwise removed such as by ladling from low drainage reservoirs is preferably recovered where possible using PVA wipes to mechanically remove any visible bio-load residue and leave a dry surface. This technique is taught in U.S Pat. Nos. 5,707,731, 2160682, 971994056, 5,885,907, 5,985,443, 6,420,284, 2,392,034, 1419848, 1237820, D493,946, 7,328,463, and 7,509,690. The preferred PVA wipes offer low product residue; hydrophilicity meaning that the spent solution is readily “mopped up”, and high strength meaning that the wipes perform well to dry even rough and irregular surfaces. The spent PVA wipe are environmentally safe. They not require medical waste management; no red bagging is required. Moreover, the spent wipes completely dissolve in boiling water, with the cooled solution containing dissolved PVA wipes being conventionally dispose of in a waste water system or even on the ground.

Next in the method of the present invention occurs the step of sanitizing and disinfecting. Hypochlorous acid (HCIO) is preferably immediately applied to the just-cleaned and dried surface, preferably by use of an electrostatic spraying system. Most preferably this spraying system is the same one most recently used to apply the sodium hydroxide.

The most preferred solution of hypochlorous acid is in water to a concentration of <0.02% hypochlorous acid with a Ph equaling 5.0 (+/−1). This solution provides from 150-200 ppm free available chlorine, with +1100 ORP. This solution is approximately eighty times (80×) more effective than bleach at the same ppm. The solution operates to sterilize and to disinfect by the Lysis kill method. It is fast acting, and typically operates in mere seconds at room temperatures. Environmentally this solution, and the spent solution, are safe. The spent solution is rapidly neutralized when recombined in waste management system. It leaves no additional carbon footprint. No additional logistics are required beyond commonly available water (H2O), salt (NaCl), and electricity. The production of the hypochlorous acid solution preferably uses the same equipment and ingredients as did the production of the hypochlorous acid solution.

Preferably optionally further in the method of the present invention a long-acting anti-microbial may be applied to the sanitized and disinfected surface at any time. It is preferably applied immediately, and is most preferably applied in accordance with U.S. Pat. No. 8,491,922 B2.

Application of the long-acting anti-microbial solution is most preferably with electrostatic sprayer. This requires that the surface itself, or at least its finish, be electrically conducting, which is normally the case. If necessary the long-acting anti-microbial solution may be applied with a common paintbrush.

The method of the present invention is preferably, and in many applications, optionally commonly extended to tracking and tracing the sanitized and disinfected status of the surface(s) that was (were) treated. In medical applications in particular it is often essential that base line bio-loads are established and monitored.

Monitoring of the (treated sanitized) surface(s) is (are) preferably realized with an ATP meter. This meter is commonly used as a quick assay to determine baseline and success of any cleaning and/or disinfecting materials and methods, and may readily and easily be so used to confirm the efficacy of the present invention. See, for example, U.S. Pat. No. 7,628,823 B2 and patent application no. 20080176250.

Note further that ATP technology as it currently exists measures total bio-Load (living and dead). Additional laboratory quality testing is preferably periodically used to confirm the accuracy of the ATP results. There are several emerging testing technologies based on ELISA that show promise and can improve the overall quality of this process. See, for example, U.S. Pat No. 8,715,590.

In accordance with the preceding explanation, the present invention will be understood to be a versatile, quick, cost effective, and biologically effective method of cleaning and of sanitizing/disinfecting diverse surfaces. The scope of the present invention should be interpreted in accordance with the following claims, only, and not solely in accordance with the most preferred materials and processes taught for use in, and with, the method of the invention.

1. A method of disinfecting a surface comprising:
first-applying sodium hydroxide to the surface as a cleaner and wiping the surface dry;
and second-applying hypochlorous acid to the surface as a disinfectant.

2. The method according to claim 1 further comprising:
third-applying a covalent bonded anti-microbial liquid to the surface.

3. The method according to claim 1 that before the first-applying step further comprises:
first-producing sodium hydroxide onsite where is located the surface to be disinfected.

4. The method according to claim 3
wherein the first producing is of sodium hydroxide is at such low ppm concentration so as not to be toxic to humans.

5. The method according to claim 4
wherein the first producing is of sodium hydroxide containing a sufficient concentration of reactive ions so as to be effective to kill the COVID-19 coronavirus.

6. The method according to claim 4
wherein the first producing of sodium hydroxide is by dilution from high concentrates.

7. The method according to claim 4
wherein the first producing is of sodium hydroxide having less than 10 ppm salt content.

8. The method according to claim 1 that before the second-applying step further comprises:
second-producing is of hypochlorous acid having a pH between 4 and 6.5.

9. The method according to claim 1 that before the second applying further comprises:
producing both sodium hydroxide and hypochlorous acid onsite where is the surface.

10. The method according to claim 8
wherein the producing of the sodium hydroxide and hypochlorous transpire onsite where is the surface is simultaneous in a same deployable device.

11. The method according to claim 3, 4, 5, 6, 7, 8 or 9.
wherein the producing uses the commonly available elements salt and water.

12. The method of claim 1 expanded and extended to maintaining disinfected the surface so treated of the COVID-19 coronavirus, the expanded and extended method comprising: repeating as necessary steps one and two so as to disinfect the surface of COVID-19 coronavirus; and third-applying a covalent bonded anti-microbial liquid to the surface so as to maintain the surface disinfected of the COVID-19 coronavirus.

13. The method according to claim 1 effective to kill hospital fungus, yeast, bacteria, virus and Acinctobacter Calcoaceticus.

14. The method of disinfecting a surface according to claim 1 wherein the step three of third-applying a covalent bonded anti-microbial to the surface comprises:
applying quaternary ammonium cations.
